(19) United States
(12) Patent Application Publication
(10) Pub. No.: US 2026/0004343 A1
(43) Pub. Date: Jan. 1, 2026

(54) SYSTEMS AND METHODS FOR EVALUATING A RENTAL CANDIDATE FOR A RENTAL EVENT

(71) Applicant: Wells Fargo Bank, N.A., San Francisco, CA (US)

(72) Inventor: Hao Li, San Francisco, CA (US)

(21) Appl. No.: 18/761,198

(22) Filed: Jul. 1, 2024

(51) Int. Cl. G06Q 40/03; G06Q 30/0645

(52) U.S. Cl. CPC G06Q 40/03; G06Q 30/0645

(57) ABSTRACT

Systems, apparatuses, methods, and computer program products are disclosed for evaluating a rental candidate for a rental event. An example method includes receiving, from a rental entity device, a rental initiation request comprising (a) a rental candidate item and (b) an indication of a rental candidate. The example method further includes receiving, from a rental candidate device, a mDL associated with the rental candidate. The example method further includes authenticating the rental candidate based on the mDL. In response to authenticating the rental candidate, the example method further includes determining a universal rental ID associated with the rental candidate, determining rental candidate information based on the universal rental ID, determining, using a risk determination model, a risk level, and providing, to the rental entity device, a rental candidate evaluation, wherein the rental candidate evaluation comprises a suitability indication of renting the rental candidate item to the rental candidate.

### BACKGROUND

Rental entities require rental candidates to provide sensitive personal information (e.g., credit scores, proof of income, employment history, rental history, etc.), for assessing their reliability and financial stability. However, conventional rental candidate evaluation systems and techniques exhibit numerous drawbacks, inefficiencies, and limitations.

### BRIEF SUMMARY

Conventional rental candidate evaluation systems, such as those provided by rental entities, operate by manually gathering and analyzing various elements of personal and financial information associated with a rental candidate. The process of performing a rental candidate evaluation is crucial for minimizing the risk of rent defaults on a rented asset. However, current rental candidate evaluation systems typically rely on manual processes, which may be time-consuming and error prone. For instance, collecting and verifying information such as income, employment history, and rental references heavily involve numerous steps and coordination with various third parties. This manual effort often leads to delays, increased administrative workload, and the potential for human error in data entry or evaluation. Moreover, inconsistencies in how rental candidate information is collected and interpreted may also result in subjective decision making, which may affect the fairness and accuracy of the rental candidate evaluation process.

Additionally, the manual nature of the rental candidate evaluation process introduces significant privacy concerns. When rental candidates provide sensitive personal information, such as social security numbers, financial records, employment details, and/or the like, there exists an inherent risk of data breaches and misuse. Without a regulated standard for storing such information across various rental entities, the chances of unauthorized access or data leaks are significantly increased. In particular, the manual handling of personal data may lead to unauthorized access and/or exposure, which not only compromises the security of the rental candidate's personal information, but also exposes rental entities to potential legal liabilities and damage to their reputations. Evidently, ensuring robust data protection measures and adoption of more secure, automated rental candidate evaluation has become imperative. As such, there is a unique need for a technical solution that automates and streamlines the rental candidate evaluation process by minimizing the manual evaluation of rental candidates. Given that rental candidate evaluation often must occur in near-real-time and in many parallel instances at scale, especially to meet time-sensitive rental evaluation deadlines, a systematic and computer-based implementation is necessary to mitigate delays and risks associated with the manual evaluation of rental candidates. In other words, there exists an underlying technical necessity for rental candidate evaluation systems that are able to autonomously provide this capability.

Example implementations described herein provide a technical solution to this technical problem, and in doing so overcome the challenges that arise from the manual evaluation of rental candidates during a rental event. In contrast to conventional techniques for evaluating a rental candidate, example embodiments described herein comprise a rental candidate evaluation system 102 configured to utilize a mobile driver's license (mDL) associated with a rental candidate to authenticate the respective rental candidate. In this regard, the rental candidate evaluation system 102 may be employed to remotely authenticate the rental candidate based on a respective mDL associated with the rental candidate. As will be described in greater detail below, utilizing mDLs that have been issued by legally entitled entities (e.g., government agencies) adds an additional layer of trust to each rental candidate evaluation facilitated by the rental candidate evaluation system 102. Furthermore, utilizing mDLs to authenticate and/or verify rental candidates ensures that only intended parties are receiving information associated with a particular rental event.

Furthermore, example implementations described herein are not limited solely to traditional rental events (e.g., renting a property, renting a car) involving a tangible rental candidate item, and may also be extended to non-tangible rental candidate items such as software as a service (SaaS), virtual private networks (VPNs), online courses and educational content, and/or the like for whom verification and/or authentication is required. In such instances, the example embodiments described herein facilitate the seamless provision of a rental evaluation whilst eliminating the need for manual documentation for identity verification. This versatile feature underscores the applicability of the technical solution across diverse rental event contexts, thereby enhancing its utility and value proposition in various operational settings.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used evaluating a rental candidate for a rental event.

FIG. 2 illustrates a schematic block diagram of example circuitry embodying a system device that may perform various operations in accordance with some example embodiments described herein.

FIG. 3 illustrates an example flowchart for evaluating a rental candidate for a rental event, in accordance with some example embodiments described herein.

FIG. 4 illustrates an example flowchart for receiving a rental initiation request comprising (a) a rental candidate item and (b) an indication of a rental candidate, in accordance with some example embodiments described herein.

FIG. 5 illustrates an example flowchart for authenticating the rental candidate based on the mDL, in accordance with some example embodiments described herein.

FIG. 6 illustrates an example flowchart for determining rental candidate information based on the universal rental ID, in accordance with some example embodiments described herein.

FIG. 7 illustrates an example flowchart for determining, using a risk determination model, a risk level indicative of an inferred risk associated with renting the rental candidate item to the rental candidate, in accordance with some example embodiments described herein.

FIG. 8 illustrates an example flowchart for providing, based on the risk level, a rental candidate evaluation of the rental candidate to the rental entity device, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “rental candidate” may refer to an individual or entity seeking to engage in a transaction for the temporary use or occupancy of a rental candidate item. The rental candidate may be authenticated through the use of a mDL and is subject to a rental evaluation process to determine their suitability for renting a specific rental candidate item.

The term “rental event” may refer to the process initiated by a rental initiation request involving the temporary transfer of possession or use of a rental candidate item from a rental entity to a rental candidate.

The term “rental candidate item” may refer to a specific asset, property, or service that a rental candidate seeks to rent or lease as part of a rental event. The rental candidate item acts as a critical component of the rental initiation request and forms the basis for the rental evaluation process.

### System Architecture

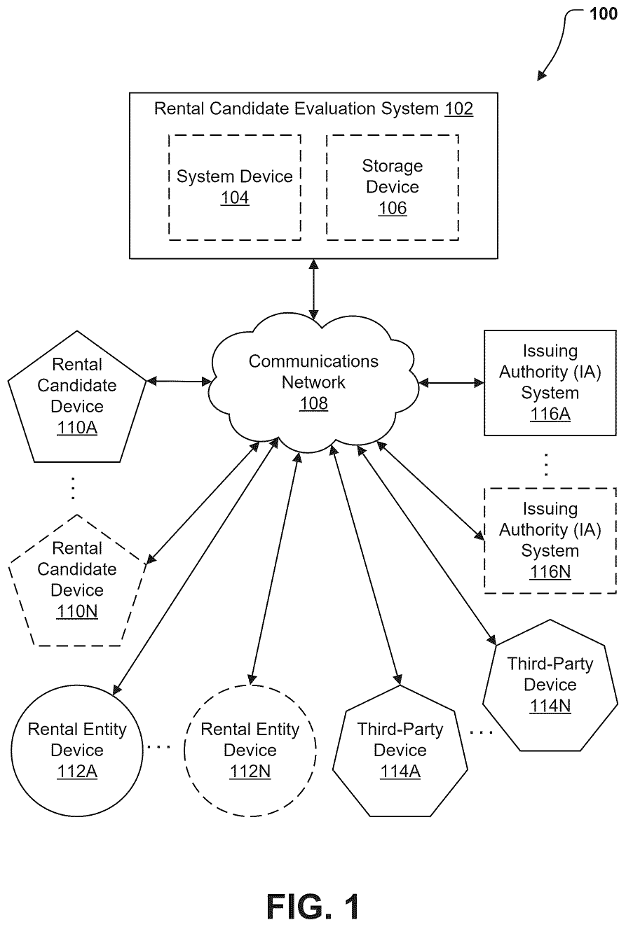

Example embodiments described herein may be implemented using any of a variety of computing devices or servers. To this end, FIG. 1 illustrates an example environment 100 within which various embodiments may operate. As illustrated, a rental candidate evaluation system 102 may receive and/or transmit information via communications network 108 (e.g., the Internet) with any number of other computing devices and/or computing systems, such as one or more of rental candidate devices 110A-110N, rental entity devices 112A-112N, third-party devices 114A-114N, and/or issuing authority (IA) systems 116A-116N. Although system device 104 and storage device 106 are described in singular form, some embodiments may utilize more than one system device 104, more than one storage device 106, and/or the like. The one or more rental candidate devices 110A-110N, rental entity devices 112A-112N, and/or third-party devices 114A-114N, may be embodied by any computing devices known in the art. The one or more rental candidate devices 110A-110N, rental entity devices 112A-112N, and/or third-party devices 114A-114N need not themselves be independent devices but may be peripheral devices communicatively coupled to other computing devices. The one or more rental candidate devices 110A-110N may include laptops, tablets, phones, whereas the one or more rental entity devices 112A-112N and/or third-party devices 114A-114N may be a device associated with a rental entity and/or a third party that performs operations related to evaluation of the rental candidate.

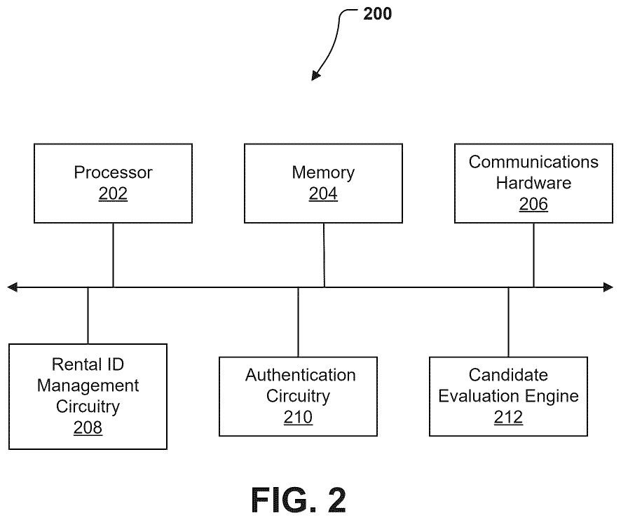

The rental candidate evaluation system 102 may be implemented as one or more computing devices or servers, which may be composed of a series of components. These components of system device 104 may be physically proximate to the other components of the rental candidate evaluation system 102, while other components are not. The system device 104 may receive, process, generate, and transmit data, signals, and electronic information to facilitate the operations of the rental candidate evaluation system 102. Particular components of the rental candidate evaluation system 102 are described in greater detail below with reference to apparatus 200 in connection with FIG. 2.

In some embodiments, the rental candidate evaluation system 102 further includes a storage device 106 that comprises a distinct component from other components of the rental candidate evaluation system 102. Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the rental candidate evaluation system 102. Storage device 106 may store information relied upon during operation of the rental candidate evaluation system 102, such as rental candidate information that may be used by the rental candidate evaluation system 102, data and documents to be analyzed using the rental candidate evaluation system 102, or the like. In addition, storage device 106 may store control signals, device characteristics, and access credentials enabling interaction between the rental candidate evaluation system 102 and one or more of the rental candidate devices 110A-110N, rental entity devices 112A-112N, third-party devices 114A-114N, and/or issuing authority (IA) systems 116A-116N.

In some embodiments, the rental candidate evaluation system 102 may be configured to facilitate the execution of one or more processes related to authenticating a rental candidate based on an mDL associated with the rental candidate. As a non-limiting example, the rental candidate evaluation system 102 may be configured to authenticate the rental candidate based on a respective mDL associated with the rental candidate to evaluate the rental candidate for a particular rental event. In this regard, the rental candidate evaluation system 102 may be configured to store, integrate with, manage, and/or utilize one or more mDLs (and/or data related to the one or more mDLs (e.g., mDL identifying information, cryptographic key information) associated with a rental candidate in order to facilitate the various operations described herein. As used herein, the term “mDL” covers various mobile (e.g., digital) identity credential types associated with a rental candidate including mobile driver's licenses and mobile identification cards. An mDL may be an electronically managed data structure configured to be accessed, processed, and/or otherwise utilized by the rental candidate evaluation system 102 for various authentication processes.

In this regard, an mDL may be configured to store or point to (e.g., programmatically reference) various credential data associated with a rental candidate including, but not limited to, personally identifiable information (PII) (e.g., given name, family name, name prefix, name suffix, driver's license number, social security number, administrative number), rental candidate information (e.g., height, eye color, hair color, age, organ donor status, veteran status, gender information, sex information, race information, ethnicity information, rental candidate portrait image data, rental candidate signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the rental candidate. Additionally, an mDL may be configured to store and/or point to various cryptographic key information (e.g., public key information used to identify the mDL, a corresponding rental candidate device, and/or a corresponding rental candidate) and/or originating IA data (e.g., cryptographic key information and/or identifying data associated with an originating IA).

An mDL may be issued (e.g., provisioned) to a rental candidate by an IA system 116A associated with a particular IA. An IA may be an entity that is legally entitled (or otherwise recognized as the relevant authority) to issue credentials, such as driver's licenses and/or other identification cards. An IA system 116A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 116A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally, or alternatively, in some embodiments, an mDL may be administered, managed, employed, and/or otherwise utilized by the rental candidate evaluation system 102 in compliance with various standards set forth by the American Association of Motor Vehicle Administrators (AAMVA). Additionally, or alternatively, in some embodiments, an mDL may be administered, managed, employed, and/or otherwise utilized by the rental candidate evaluation system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a rental candidate and may comprise and/or be associated with the same data as the legal credential. In some embodiments, an mDL associated with a rental candidate may be stored in a storage device (e.g., a server system) of an IA system 116A and one or more portions of credential data related to the mDL may be retrieved in real time, or near-real time, during a transaction associated with the rental candidate (e.g., an online transaction requiring rental candidate verification, rental candidate authentication, rental candidate age verification, and/or the like). Additionally, or alternatively, once an mDL is issued to a rental candidate by a respective IA (e.g., by way of a corresponding IA system 116A), the mDL may be stored locally on a rental candidate device associated with the rental candidate (e.g., rental candidate device 110A) such that the mDL may be used without relying on a communications network (e.g., communications network 108). Additionally, or alternatively, in some embodiments, an mDL may be stored in a smart mobile wallet associated with the rental candidate and managed by the rental candidate evaluation system 102, and the mDL may be accessed and/or utilized by the rental candidate via the smart mobile wallet to execute various mDL-based transactions.

In some examples, an IA may provision an mDL to a particular rental candidate device (e.g., rental candidate device 110A) associated with a rental candidate such that the mDL is associated with various rental candidate device data related to the particular rental candidate device (e.g., cryptographical identification data such as a public key). This may ensure that an mDL associated with a rental candidate cannot be transferred to multiple devices without authorization by the IA system (e.g., IA system 116A) and used in fraudulent transactions. Furthermore, associating an mDL with a particular rental candidate device (e.g., rental candidate device 110A) also enables the rental candidate evaluation system 102 and/or an IA system of an IA (e.g., IA system 116A) to verify that the intended rental candidate of the mDL is in possession of the mDL. Further still, associating an mDL with a particular rental candidate device (e.g., rental candidate device 110A) also ensures the safe transfer of sensitive credential data to and/or from the intended rental candidate of the mDL. In various examples, a rental candidate may store multiple copies of an mDL on multiple rental candidate devices (e.g., rental candidate devices 110A-110N). However, in such examples, each respective copy of the mDL may be cryptographically coupled to a respective rental candidate device by the IA system (e.g., IA system 116A) which provisioned the mDL. In this manner, each copy of the mDL can be independently verified against a respective rental candidate device to ensure that an mDL, or credential data associated with the mDL, cannot be transferred to unauthorized rental candidate devices.

An mDL may be associated with various mDL data security mechanisms used to ensure the validity of the mDL, authenticate an originating IA that issued the mDL, protect a rental candidate's personal data, and/or facilitate secure mDL-based transactions. In this regard, an mDL may be associated with a mobile security object (MSO) and/or various public and private cryptographic key information. An MSO is an electronically managed data structure that enables the authentication of the accuracy and origin of various credential data associated with the mDL during mDL-based transactions. In various examples, an MSO is associated with one or more portions of credential data related to the issue date, expiration date, rental candidate signature, and/or expected credential update time associated with the mDL. In various embodiments, the one or more portions of credential data associated with the MSO may be used to verify the validity and/or status of the mDL during various transactions. For example, if the credential data associated with the MSO indicates that the mDL is expired, the corresponding rental candidate may not be evaluated for the rental event.

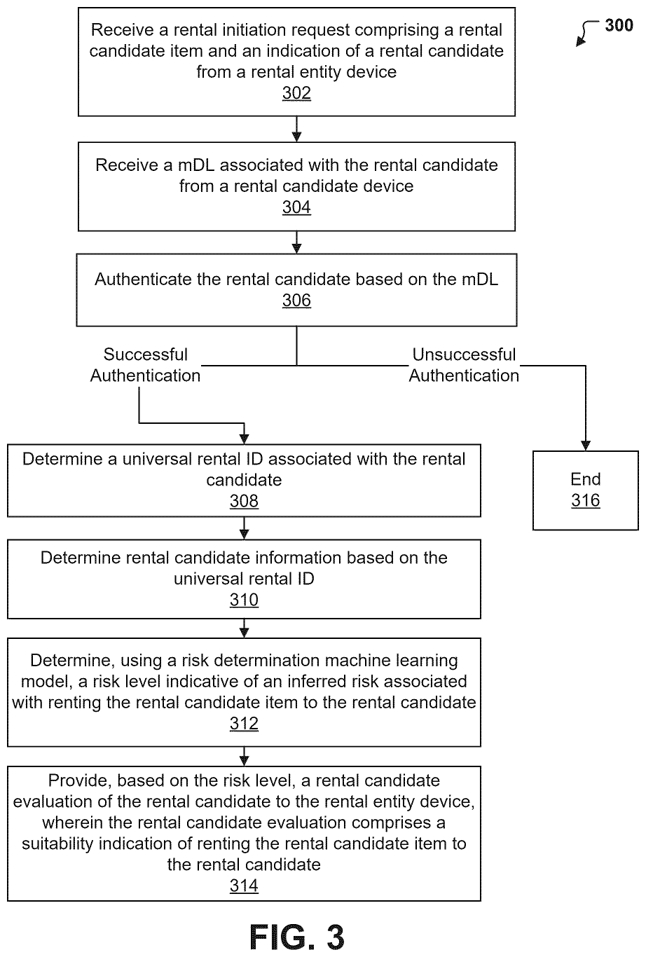

Additionally, an mDL may be associated with various cryptographic key information (e.g., public/private key pair information) that may be utilized by the rental candidate evaluation system 102 to authenticate an originating IA that issued the mDL, verify one or more portions of credential data associated with an mDL, and/or facilitate various mDL-based transactions (e.g., rental candidate authentication protocols, mDL data queries) for a rental candidate associated with the mDL. For example, an IA associated with a respective IA system 116A may be associated with a unique public key that may be utilized by the rental candidate evaluation system 102 to identify and/or authenticate the originating IA of a respective mDL. As such, in various examples, an mDL may be configured to store and/or point to the public key information associated with the IA from which the mDL was provisioned. Additional details related to the execution of various operations related to one or more mDLs associated with a rental candidate by the rental candidate evaluation system 102 will be described in greater detail herein with reference to FIGS. 3-8.

In some embodiments, the rental candidate evaluation system 102 further comprises and/or integrates with a storage device that comprises a distinct component from other components of the rental candidate evaluation system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Additionally, or alternatively, the storage device may host the software executed to operate the rental candidate evaluation system 102. Additionally or alternatively, the storage device may store information relied upon during operation of the rental candidate evaluation system 102, such as various rental candidate data (e.g., rental candidate information), mDL data (e.g., cryptographical information, credential information), rental entity data (e.g., payment account data, rental candidate transaction data, product and/or service data), smart mobile wallet data (e.g., payment account data, payment card data, and/or the like associated with a rental candidate), distribution data, logistical data, legal data, software application framework data, etc.), and/or the like configured in various data formats to be utilized by the rental candidate evaluation system 102. In addition, the storage device may store control signals, device characteristics, and/or access credentials enabling interaction between the rental candidate evaluation system 102 and/or one or more of the rental candidate devices 110A-110N, rental entity devices 112A-112N, and/or third-party devices 114A-114N.

### Example Implementing Apparatuses

The rental candidate evaluation system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-8. As illustrated in FIG. 2, the apparatus 200 may include processor 202, memory 204, communications hardware 206, rental ID management circuitry 208, authentication circuitry 210, and a candidate evaluation engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a rental entity and/or a rental candidate and, in some embodiments, to receive an indication of rental candidate input. In this regard, the communications hardware 206 may comprise an interface, such as a display, and may further comprise the components that govern use of the interface, such as a web browser, mobile application, dedicated rental candidate device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these rental candidate device interface elements through software instructions (e.g., application software and/or system software, such as firmware) stored on a memory (e.g., memory 204) accessible to the processor 202.

The communications hardware 206 may further be configured to facilitate the execution of one or more mDL authentication and/or IA authentication operations for a rental entity associated with the rental candidate evaluation system 102. In various circumstances, an IA system (e.g., IA system 116A) that previously issued an mDL to a rental candidate may periodically update credential data associated with the mDL (e.g., new rental candidate contact information, updated credential restrictions, updated credential endorsements). As such, the communications hardware 206 may be configured to retrieve and/or receive updated credential data associated with a rental candidate's mDL from an IA system (e.g., IA system 116A) and facilitate the updating of the rental candidate's mDL based on the updated credential data. For example, if an mDL associated with a rental candidate is stored in a smart mobile wallet being managed by the rental candidate evaluation system 102, the communications hardware 206 may be configured to receive updated credential data associated with the rental candidate's mDL from the originating IA system (e.g., IA system 116A) and subsequently update the rental candidate's mDL in the smart mobile wallet based on the updated credential data.

In some embodiments, the communications hardware 206 may update an mDL stored on a rental candidate device (e.g., rental candidate device 110A). In such embodiments, the communications hardware 206 may be configured to query one or more storage devices (e.g., server systems) associated with an IA system (e.g., IA system 116A) in order to retrieve current and/or updated credential data in response to one or more interactions with a rental candidate device interface associated with the smart mobile wallet. Additionally, or alternatively, the communications hardware 206 may be configured to periodically query to one or more storage devices (e.g., server systems) associated with an IA system (e.g., IA system 116A) based on a predefined schedule (e.g., once a day, once a week, once a month, once every 90 days) in order to retrieve current and/or updated credential data associated with a rental candidates' mDL.

In various examples, an IA (e.g., a branch of the DMV) associated with a respective IA system (e.g., IA system 116A) may enforce various mDL data freshness requirements associated with the mDLs the IA system provisions to rental candidates. In this regard, an MSO associated with a respective mDL may indicate a technical validity period associated with the mDL (e.g., a 30-day validity period). As such, the communications hardware 206 may utilize the technical validity period indicated by the MSO to ensure that the credential data associated with the mDL stored on a rental candidate device (e.g., rental candidate device 110A) is updated and/or current. For example, if the communications hardware 206 determines that the technical validity period indicated by the MSO has expired, the mDL may be invalidated until the credential data associated with the mDL is refreshed (e.g., updated, verified) by the IA system 116A associated with the IA from which the mDL was issued. In some examples, the technical validity period of the mDL indicated by the MSO may be shorter than a validity period of the mDL and/or the corresponding physical legal credential associated with the mDL (e.g., an expiration date of a driver's license associated with the mDL).

For example, legal credentials (e.g., a driver's license and/or the corresponding mDL) are commonly associated with a relatively long validity period (e.g., five to seven years from the date of issue of the legal credential). However, problems may arise if an IA assigns various credential restrictions (e.g., driving restrictions) and/or credential endorsements (e.g., weighted vehicle endorsements) to a particular rental candidate's legal credential, yet the rental candidate fails to have the legal credential (e.g., a corresponding physical credential) updated with said credential restrictions and/or credential endorsements. To address such problems, if the communications hardware 206 determines that the technical validity period indicated by the MSO of the mDL has expired, the corresponding mDL may flag the mDL such that the mDL will fail various authentication protocols during an mDL-based authentication process.

In this regard, the communications hardware 206 may be configured to facilitate the resetting of the technical validity period indicated by the MSO of the mDL in conjunction with a corresponding IA system (e.g., IA system 116A). Additionally, or alternatively, the communications hardware 206 may be configured to facilitate the updating and/or verification of the credential data associated with an mDL stored on a rental candidate device (e.g., rental candidate device 110A) each time the technical validity period associated with the MSO of the mDL is reset. This mDL data security mechanism ensures that the credential data associated with a rental candidate's mDL is always accurate and up to date.

As described herein, an mDL may be associated with various cryptographic key information (e.g., public/private key pair information) that may be utilized by the rental candidate evaluation system 102 to authenticate an originating IA that issued the mDL, verify one or more portions of credential data associated with an mDL, and/or facilitate various mDL-based transactions (e.g., rental candidate authentication protocols, mDL data queries) for a rental candidate associated with the mDL. In this regard, the communications hardware 206 may be configured to generate and/or transmit an IA authentication request comprising a public key associated with an IA to a corresponding IA system 116A in order to verify that a particular mDL was indeed provisioned by the IA associated with the IA system 116A.

In some examples, an mDL may only comprise (e.g., store, point to) identifying information related to a particular IA such that the communications hardware 206 may be configured to first obtain a public key associated with the IA from a corresponding IA system 116A based on the identifying information. Once the public key information associated with the IA is obtained, the communications hardware 206 may be configured to generate an IA authentication request comprising the public key of the IA and transmit the IA authentication request to the IA system 116A (e.g., via the communications network 108). As such, the communications hardware 206 may be configured to receive, from an IA system (e.g., IA system 116A) and in response to the IA authentication request, one or more portions of data indicating whether the IA is a bona fide IA and/or whether the mDL indeed originated from the IA.

Once the communications hardware 206 confirms the validity of the IA and/or confirms that a particular mDL associated with a rental candidate originated from the IA, the communications hardware 206 may be configured to generate a digital token comprising cryptographical information (e.g., public key information) associated with the mDL and the rental candidate. Additionally, in some embodiments, the cryptographical information associated with the mDL and comprised in the digital token may be rental candidate device identification data by which a rental candidate device (e.g., rental candidate device 110A) of the rental candidate may be uniquely identified. In various examples, the communications hardware 206 may generate and/or transmit the digital token to an IA system (e.g., IA system 116A) such that the IA system may decrypt the cryptographical information comprised in the digital token. In this manner, the IA system (e.g., IA system 116A) may authenticate (e.g., verify) one or more portions of credential data associated with the mDL and/or one or more portions of rental candidate device identification data associated with the rental candidate device (e.g., rental candidate device 110A). In this regard, the communications hardware 206 may be configured to receive, from the IA system (e.g., IA system 116A) and in response to transmitting the digital token, one or more portions of data indicating whether the mDL and/or the rental candidate device (e.g., rental candidate device 110A) identified by the digital token is valid. Furthermore, in various examples, the communications hardware 206 may be configured to receive, from the IA system (e.g., IA system 116A) and in response to transmitting the digital token, one or more portions of credential data associated with the mDL.

In some embodiments, the communications hardware 206 may be configured to generate a digital token comprising cryptographical information (e.g., public key information) associated with an mDL and/or a rental candidate device (e.g., rental candidate device 110A) associated with a particular rental candidate in response to an mDL authentication request associated with the particular rental candidate. In some embodiments, the mDL authentication request may be a request to authenticate an mDL associated with the particular rental candidate and thereby authenticate the identity of the particular rental candidate for one or more mDL-based transactions. A respective mDL authentication request may comprise one or more of cryptographical information (e.g., public key information) associated with an mDL and/or a rental candidate device (e.g., rental candidate device 110A). Additionally, or alternatively, a respective mDL authentication request may comprise one or more desired data elements (e.g., one or more desired portions of credential data) associated with the mDL, location data, rental candidate profile data, rental candidate account data, social media data, smart mobile wallet identification data, rental candidate device identification data, and/or the like associated with the particular rental candidate.

In various examples, an mDL validity response received from an IA system (e.g., IA system 116A) based on a digital token generated by the communications hardware 206 may comprise the entirety of the credential data associated with the mDL of the particular rental candidate. Additionally, or alternatively, in various other examples, an mDL validity response received from an IA system (e.g., IA system 116A) based on a digital token generated by the communications hardware 206 may comprise a verification of the desired credential data associated with the mDL that was indicated by an mDL authentication request. Additionally, or alternatively, in various other examples, an mDL validity response received from an IA system (e.g., IA system 116A) based on a digital token generated by the communications hardware 206 may comprise a verification of the rental candidate device identification data associated with the rental candidate device (e.g., rental candidate device 110A) of the particular rental candidate. For example, the mDL validity response may verify that the rental candidate device currently associated with the mDL is the same (e.g., intended) rental candidate device that the mDL was originally provisioned to. In this manner, the rental candidate evaluation system 102 may be configured to confirm the validity of the mDL data of an mDL associated with a particular rental candidate in order to authenticate the identity of the particular rental candidate. Additionally, this enables the rental candidate evaluation system 102 to confirm whether the intended rental candidate and/or rental candidate device (e.g., rental candidate device 110A) associated with the mDL is currently in possession of the mDL. These and other operations associated with the communications hardware 206 will be described in further detail herein below with reference to FIGS. 3-8.

In addition, the apparatus 200 further comprises rental ID management circuitry 208. In some embodiments, the rental ID management circuitry 208 may be configured to determine a universal rental identifier associated with the rental candidate and determine rental candidate information based on the universal rental ID. Additionally, the rental ID management circuitry 208 may utilize processor 202, memory 204, or any other hardware component included in the apparatus 200 to perform these operations, as described in connection with FIGS. 3-8 below. The rental ID management circuitry 208 may further utilize the communications hardware 206 to gather data from, or transmit data to, a variety of sources (e.g., one or more of the rental candidate devices 110A-110N, rental entity devices 112A-112N, third-party devices 114A-114N, issuing authority (IA) systems 116A-116N, and/or any storage devices associated with the rental candidate evaluation system 102), and/or exchange data with a rental candidate, rental entity, and/or a third-party. In some embodiments, the rental ID management circuitry 208 may work in conjunction with the authentication circuitry 210 and/or the candidate evaluation engine 212 in order to execute one or more of the methods described herein. For example, in some embodiments, the rental ID management circuitry 208 may integrate with and/or otherwise leverage the authentication circuitry 210 to facilitate the authentication of a rental candidate based on a respective mDL associated with the rental candidate.

In addition, the apparatus 200 further comprises authentication circuitry 210. In some embodiments, the authentication circuitry 210 may be configured to facilitate the execution of one or more rental candidate authentication operations for a rental entity associated with the rental candidate evaluation system 102. Additionally, the authentication circuitry 210 may utilize processor 202, memory 204, to perform these operations, as described in connection with FIGS. 3-8 below. The authentication circuitry 210 may further utilize the communications hardware 206 to gather data from, or transmit data to, a variety of sources (e.g., one or more of the rental candidate devices 110A-110N, rental entity devices 112A-112N, third-party devices 114A-114N, issuing authority (IA) systems 116A-116N, and/or any storage devices associated with the rental candidate evaluation system 102), and/or exchange data with a rental candidate, a rental entity, and/or a third-party. In some embodiments, the authentication circuitry 210 may work in conjunction with the communications hardware 206, rental ID management circuitry 208 and/or the candidate evaluation engine 212 in order to execute one or more of the methods described herein. For example, in some embodiments, the authentication circuitry 210 may integrate with and/or otherwise leverage the communications hardware 206 rental ID management circuitry 208 to facilitate the authentication of a rental candidate based on a respective mDL associated with the rental candidate.

Additionally, the authentication circuitry 210 may be configured to identify a smart mobile wallet associated with a rental candidate and/or the like. For example, the authentication circuitry 210 may identify a smart mobile wallet associated with a rental candidate based on rental candidate information, third-party rental candidate information, and/or the like associated with the rental candidate. In some embodiments, rental candidate information, third-party rental candidate information, and/or the like associated with a rental candidate may comprise rental candidate profile data, rental candidate account data, rental candidate contact data, social media data, location data, and/or smart mobile wallet identification data associated with the rental candidate.

In various examples, once the authentication circuitry 210 identifies a smart mobile wallet that is ostensibly associated with the rental candidate, the authentication circuitry 210 may be configured to generate a rental candidate information request. The authentication circuitry 210 may be configured to leverage the communications hardware 206 to transmit a rental candidate information request to the smart mobile wallet ostensibly associated with the rental candidate. Furthermore, the authentication circuitry 210 may be configured to leverage the communications hardware 206 to receive rental candidate information from the smart mobile wallet ostensibly associated with the rental candidate based on the rental candidate information request.

In various examples, the rental candidate identification data associated with a rental candidate comprises cryptographical information associated with one or more of an mDL and/or a rental candidate device 110A associated with the rental candidate. In some embodiments the cryptographical information associated with the mDL and/or the rental candidate device may be a public key of a public/private key pair, where the public key is provisioned to the rental candidate by an IA upon issuance of the mDL. Such cryptographical information may be utilized by the rental candidate evaluation system 102 and/or an IA system (e.g., IA system 116A) associated with the IA that provisioned the mDL to verify and/or authenticate the mDL, one or more portions of desired mDL credential data, and/or the rental candidate device associated with the rental candidate. In this regard, the authentication circuitry 210 may be configured to determine that the smart wallet ostensibly associated with the rental candidate and/or the like is indeed associated with the rental candidate.

Additionally, or alternatively, in some embodiments, the authentication circuitry 210 may be configured to facilitate execution of secondary authentication of a rental candidate in addition to authenticating the rental candidate based on a corresponding mDL. In this regard, the authentication circuitry 210 may be configured to facilitate the execution of a second factor of authentication including one or more of facial recognition, voice recognition, and/or biometric authentication techniques (e.g., fingerprint recognition, retina recognition, iris recognition). For example, the authentication circuitry 210 may be configured to prompt a rental candidate via a rental candidate device (e.g., rental candidate device 110A) to authenticate themselves via a second factor of authentication (e.g., biometric authentication based on fingerprint data) before allowing the rental candidate to access a smart mobile wallet managed by the rental candidate evaluation system 102. Additionally, or alternatively, in various embodiments, the authentication circuitry 210 may be configured to prompt a rental candidate via a rental candidate device (e.g., rental candidate device 110A) to authenticate themselves via a second factor of authentication (e.g., voice recognition) either prior to or subsequent to authenticating the rental candidate based on an mDL associated with the rental candidate.

Additionally, or alternatively, in some embodiments, the authentication circuitry 210 may be configured to employ one or more facial recognition techniques to authenticate a rental candidate during a secondary authentication process. For example, authentication circuitry 210 may be configured to authenticate a rental candidate by matching image data related to the rental candidate's face that is captured in real time, or near-real time, (e.g., via a camera of a rental candidate device 110A) to rental candidate portrait image data associated with an mDL related to the rental candidate. In this regard, the authentication circuitry 210 may be configured to generate an image matching score based on matching the image data of the rental candidate's face captured in real time, or near-real time, to the rental candidate portrait image data associated with the rental candidate's mDL.

As such, the authentication circuitry 210 may be configured to determine if an image matching score (e.g., a numerical value or the like) satisfies a respective image matching threshold (e.g., a numerical value or the like). The image matching score may satisfy the respective image matching threshold if the image matching score is greater than or equal to the respective image matching threshold (e.g., to within an error value of ±1%, ±5%, or any other number). In other examples, the image matching score (e.g., a numerical value or the like) may satisfy the respective image matching threshold (e.g., a numerical value or the like) if the image matching score is less than or equal to the respective image matching threshold (e.g., to within an error value of ±1%, ±5%, or any other number). In this manner, the authentication circuitry 210 may facilitate secondary authentication techniques in order to authenticate a rental candidate before allowing the rental candidate to access a respective smart mobile wallet via a rental candidate device (e.g., rental candidate device 110A). These and other operations associated with the authentication circuitry 210 will be described in further detail herein below with reference to FIGS. 3-8.

In addition, the apparatus 200 further comprises candidate evaluation engine 212. In some embodiments, the candidate evaluation engine 212 may be configured to determine a risk level indicative of an inferred risk associated with renting the rental candidate item to the rental candidate, wherein the risk level is determined based on the rental candidate item and rental candidate information. Additionally, the candidate evaluation engine 212 may utilize processor 202, memory 204, to perform these operations, as described in connection with FIGS. 3-8 below. The candidate evaluation engine 212 may further utilize the communications hardware 206 to gather data from, or transmit data to, a variety of sources (e.g., one or more of the rental candidate devices 110A-110N, rental entity devices 112A-112N, third-party devices 114A-114N, issuing authority (IA) systems 116A-116N, and/or any storage devices associated with the rental candidate evaluation system 102), and/or exchange data with a rental candidate, rental entity, and/or the like. In some embodiments, the candidate evaluation engine 212 may work in conjunction with the rental ID management circuitry 208 and/or the authentication circuitry 210 in order to execute one or more of the methods described herein, such as selecting a risk assessment type based on the rental candidate item, wherein the risk assessment type is associated with at least one rental requirement, generating a risk score using a risk determination model, wherein the risk score is generated based on a comparison between the at least one rental requirement and the rental candidate information, and determining the risk level based on the risk score using the risk determination model. These and other operations associated with the candidate evaluation engine 212 will be described in further detail herein below with reference to FIGS. 3-8.

Although components 202-212 are described in part using functional language, it will be understood that the particular implementations necessarily include the use of particular hardware. It should also be understood that certain of these components 202-212 may include similar or common hardware. For example, the rental ID management circuitry 208, the authentication circuitry 210, and/or the candidate evaluation engine 212 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” and/or “engine” with respect to elements of the apparatus therefore shall be interpreted as necessarily including the particular hardware configured to perform the functions associated with the particular element being described. Of course, while the term “circuitry” and/or “engine” should be understood broadly to include hardware, in some embodiments, the term “circuitry” and/or “engine” may, in addition, refer to software instructions that configure the hardware components of the apparatus 200 to perform the various functions described herein.

Although the rental ID management circuitry 208, the authentication circuitry 210, and/or the candidate evaluation engine 212 may leverage processor 202, memory 204, and/or communications hardware 206 as described above, it will be understood that any of the rental ID management circuitry 208, the authentication circuitry 210, and/or the candidate evaluation engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the rental ID management circuitry 208, the authentication circuitry 210, and/or the candidate evaluation engine 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

Turning to FIGS. 3-8, example flowcharts are illustrated that contain example operations implemented by example embodiments described herein. The operations illustrated in FIGS. 3-8 may, for example, be performed by system device 104 of the rental candidate evaluation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, rental ID management circuitry 208, authentication circuitry 210, candidate evaluation engine 212, and/or any combination thereof. It will be understood that user interaction with the rental candidate evaluation system 102 may occur directly via communications hardware 206 or may instead be facilitated by a separate rental candidate device 110A-110N and/or rental entity device 112A-112N, as shown in FIG. 1, and which may have similar or equivalent physical componentry facilitating such user interaction.

Turning first to FIG. 3, a procedure 300 illustrates example operations for evaluating a rental candidate for a rental event, wherein the apparatus 200 includes means such as processor 202, memory 204, communications hardware 206, rental ID management circuitry 208, authentication circuitry 210, candidate evaluation engine 212, or the like. In some embodiments, prior to beginning the operations of FIG. 3, the communications hardware 206 may transmit a rental requirement request to the rental entity device, requesting the rental entity to provide the rental requirements for renting a rental candidate item to a rental candidate. Examples of rental requirements include credit score, proof of employment, verified address. Additionally, the rental entity may provide the third-party performing the rental evaluation of the rental candidate with a database of rental candidate items and the corresponding rental requirements for renting each rental candidate item.

In alternate embodiments, transmittal of a rental requirement request may not be required, and instead the communications hardware 206 may receive the rental requirements associated with renting a rental candidate item to a rental candidate as part of the rental initiation request. The process of receiving a rental initiation request is described further below in connection with operation 302.

As shown by operation 302, the apparatus 200 includes means such as processor 202, memory 204, communications hardware 206, or the like for receiving a rental initiation request comprising (a) a rental candidate item and (b) an indication of a rental candidate from a rental entity device. A rental initiation request may refer to a communication received by a rental entity device from a rental candidate device to initiate the rental process for a rental event. The rental initiation request may comprise two key components: a rental candidate item, which specifies the asset or service the rental candidate seeks to rent, and an indication of the rental candidate, which identifies the individual or entity requesting the rental candidate item. Examples of rental candidate items include automobiles, hotel rooms, rental properties, smart lockers, recreational equipment (e.g., bicycles, kayaks, music gear, etc.), event spaces, and/or the like.

For a particular rental event, communications hardware 206 may receive a rental initiation request from a rental candidate device (e.g., rental candidate device 110A) associated with a rental candidate. In such embodiments, wherein the rental candidate submits the rental initiation request, the rental candidate may use the rental candidate device (e.g., rental candidate device 110A) to submit the rental initiation request through a web portal associated with the rental entity, via a mobile application provided by the rental entity, and/or the like. In particular, the rental candidate device 110A-110N may establish a communication link via communications hardware 206 with a rental entity device 112A-112N via available network protocols (e.g., Bluetooth, near-field communication (NFC) (e.g., tapping the rental candidate device 110A against an NFC-enabled rental entity device 112A), Wi-Fi, internet protocols such as HTTP/HTTPS), and/or the like. A rental candidate device 110A may establish a secure connection the rental entity's server using encryption protocols, such as TLS/SSL to ensure data privacy and integrity. Alternatively, the data entered by the rental candidate as part of the rental initiation request may be packaged into a standard format (e.g., JSON or XML) and transmitted to the system device 104 of the rental candidate evaluation system 102 via an application programming interface (API) or web service call.

In some embodiments, a rental entity device 112A may also prompt the rental candidate through communications hardware 206 to submit a rental initiation request. For instance, the rental entity device may continuously monitor for the presence of nearby rental candidate devices using various proximity detection technologies such as Bluetooth, NFCs, Wi-Fi, and/or the like. Once, the rental entity device 112A detects a nearby device, the rental entity device 112A may be configured to use communications hardware 206 an attempt to identify the detected device as a potential rental candidate device. This may be done via the implementation of device handshake protocols (i.e., engaging in initial communication exchanges with the detected device to verify that the detected device is compatible and supports the necessary rental initiation request protocols), service discovery (e.g., querying the detected device for specific services or applications required for the rental process), and/or the like. Upon successful identification of a rental candidate device 110A, the rental entity device 112A may leverage communications hardware 206 to trigger a prompting mechanism to output a prompt to the rental candidate device and request the rental candidate to submit a rental initiation request. In some embodiments, the prompt may be a visual prompt (e.g., displaying messages or instructions on the rental candidate device 110A or the rental entity device 112A via a kiosk or smart terminal screen), audible prompt (e.g., emitting sounds or voice instructions to attract the attention of the rental candidate), device notifications (e.g., transmitting push notifications or messages directly to the rental candidate device 110A through a mobile application notification or text message), and/or the like. As such, the rental candidate may submit a rental initiation request through an outputted prompt.

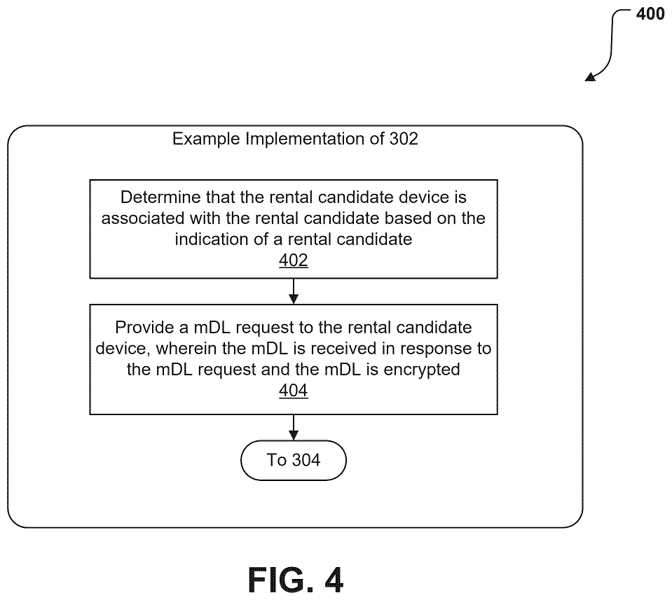

In some embodiments, operation 302 may be performed in accordance with the operations described in FIG. 4. Turning now to FIG. 4, a procedure 400 illustrates example operations for receiving a rental initiation request comprising (a) a rental candidate item and (b) an indication of a rental candidate from a rental entity device.

As shown by operation 402, the apparatus 200 includes means, such as authentication circuitry 210, or the like, for determining that the rental candidate device is associated with the rental candidate based on the indication of a rental candidate. The rental candidate device 110A, upon receiving the aforementioned prompt may be displayed a guided user interface (GUI) that provides step-by-step instructions for submission of a rental initiation request. The GUI may allow the rental candidate to input necessary details about the rental candidate item, rental candidate information, and/or the like. Examples of data the rental candidate may input include: (i) rental item type (e.g., the category or type of rental candidate item—hotel room, rental property, smart locker, etc.), (ii) item details (e.g., make and model of a car, room type and amenities for the hotel), rental period (i.e., start date and time for the rental period), location information (e.g., pickup location, return location, return property address), payment information (e.g., payment method to be used, payment authorization such as a pre-authorization amount), special requests (e.g., child seat for a car rental), rental candidate preferences (e.g., smoking or non-smoking room), and/or the like. As part of the rental initiation request, the rental candidate must also provide an indication (i.e., identifying information of the rental candidate such as name, user ID, email address, contact information). The rental candidate may provide a mobile driver's license as supporting documentation for the indication. Upon filling all data fields of the rental initiation request, the rental candidate may submit the rental initiation request, after which communications hardware 206 of the rental candidate evaluation system may receive and transmit the rental initiation request securely to the internal network of the rental entity (e.g., through an intranet or secure API call to the backend server). The system device 104 may log the rental initiation request, noting the rental candidate who submitted the request and the timestamp.

Upon receiving the rental initiation request, the authentication circuitry 210 may be configured to process the rental initiation request by performing an initial integrity check to ensure that the received rental initiation request has not been corrupted during transmission. This may involve verifying checksums or digital signatures. Additionally, the authentication circuitry 210 may check that the data fields in the rental initiation request conform to the expected format and structure, ensuring that all required data fields are present and correctly formatted. Subsequently, the authentication circuitry 210 may cause processing of the received rental initiation request for interpretation of the data fields included in the rental initiation request. In some embodiments, the authentication circuitry 210 may do this by extracting individual data fields (e.g., the rental candidate item and the indication of the rental candidate) from the rental initiation request and may subsequently organize the extracted data into a structured format, typically as objects or records that may be easily processed further. For instance, the authentication circuitry 210 may ensure that the extracted data fields are correctly associated with their respective entities (e.g., linking the rental candidate's indication with the corresponding rental item in the internal network of the rental candidate evaluation system 102). In some embodiments, the authentication circuitry 210 may validate the structured data to ensure that the data values make sense within the context of the rental event (e.g., checking item availability to ensure that the rental candidate item is available for the specified dates, ensuring that the contact information adheres to expected formats, etc.). In some embodiments, the authentication circuitry 210 may temporarily store the parsed and validated rental candidate information in memory 204 for further processing. This allows the rental candidate evaluation system 102 to maintain the context of the rental initiation request as it progresses through subsequent steps of the rental evaluation process.

Finally, as shown by operation 404, the apparatus 200 includes means, such as communications hardware 206, or the like, for providing a mDL request to the rental candidate device, wherein the mDL is received in response to the mDL request and the mDL is encrypted. If the rental initiation request does not include a mDL associated with the rental candidate, the communications hardware 206 may output a mDL request to the rental candidate device 110A from the rental initiation request was originally received, to request the rental candidate to resubmit the rental initiation request with the mDL of the rental candidate. The communications hardware 206 may also perform the aforementioned operation in instances in which the rental candidate mDL in the rental initiation request is unreadable.

In alternate embodiments, wherein the communications hardware 206 detects that the recipient candidate mDL is missing from the rental initiation request, the communications hardware 206 may automatically retrieve the mDL from the rental candidate device 110A (e.g., from a smart mobile wallet), or may retrieve the rental candidate mDL from a mDL database in storage device 06 of the rental candidate evaluation system 102 (e.g., in cases where the rental candidate's mDL was stored for a former rental initiation request). Additionally, in alternate embodiments, wherein the communications hardware 206 detects that the rental candidate mDL is missing from the rental initiation request and/or that the rental candidate mDL is corrupted, the communications hardware 206 may automatically proceed to operation 316 and failover to a traditional rental evaluation process.

Returning to FIG. 3, as shown by operation 304, the apparatus 200 includes means such as communications hardware 206, authentication circuitry 210, or the like, for receiving a mobile driver's license (mDL) associated with the rental candidate from a rental candidate device. Once the communications hardware 206 receives the rental candidate mDL associated with the rental candidate, the communications hardware 206 may verify that the rental candidate is in control of the rental candidate device 110A by capturing in real-time an image of the rental candidate associated with the rental candidate device 110A and may store the captured image for future comparison against a decrypted version of the encrypted mDL submitted as part of the rental initiation request. In some embodiments, the communications hardware 206 may output an image capture request to the rental candidate using the rental candidate device 110A. Subsequently, the captured image may be securely transmitted from the rental candidate device 110A to the authentication circuitry 210 via communications hardware 206. Once the mDL is decrypted, the authentication circuitry 210 may perform real-time analysis and verification of the captured image using advanced facial recognition algorithms. In particular, the authentication circuitry 210 may verify facial features such as eyes, nose, mouth, overall facial structure by comparing them against the facial features present in the decrypted rental candidate mDL. In particular, the mDL may be digitally signed with a private cryptographical key of an issuing authority to ensure its authenticity and integrity. To decrypt the encrypted mDL, the communications hardware 206 may proceed to operation 306 as described below.

In some embodiments, the authentication circuitry 210 may implement anti-spoofing measures (e.g., liveness detection such as blinking and facial movements, depth analysis, etc.) to ensure authenticity of the captured image. Based on a comprehensive analysis of the aforementioned features following decryption of the mDL, the authentication circuitry 210 may verify the rental candidate as being in control of the rental candidate device 110A, in which case subsequent operations may be performed to authenticate the rental candidate based on their corresponding mDL, as described below in operation 306.

As shown by operation 306, the apparatus 200 includes means, such as authentication circuitry 210, or the like, for authenticating the rental candidate based on the mDL.

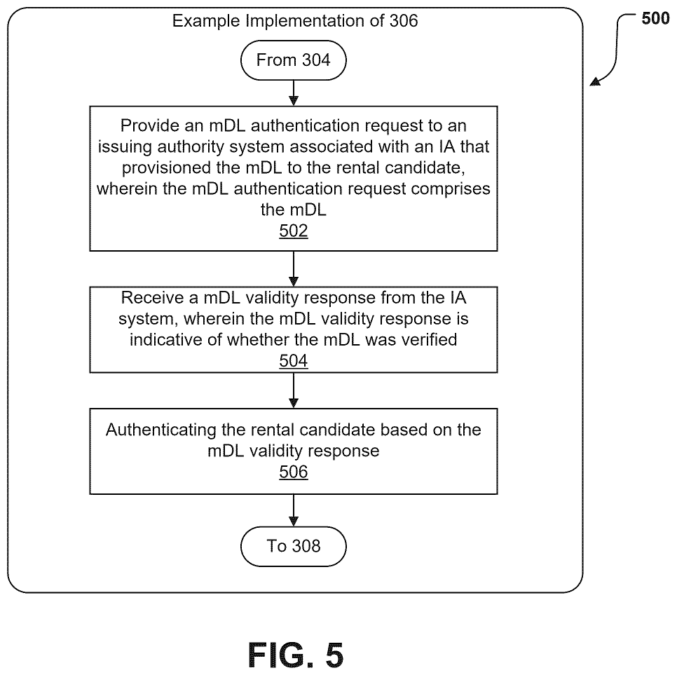

In some embodiments, operation 306 may be performed in accordance with the operations described in FIG. 5. Turning now to FIG. 5, a procedure 500 illustrates example operations for authenticating the rental candidate based on the mDL.

As shown by operation 502, the apparatus 200 includes means, such as communications hardware 206, authentication circuitry 210, or the like, for providing an mDL authentication request to an issuing authority (IA) system associated with an IA that provisioned the mDL to the rental candidate, wherein the mDL authentication request comprises the mDL. The mDL authentication request is a request to authenticate the rental candidate mDL associated with the rental candidate. Upon verifying that the rental candidate is in control of the rental candidate device, the communications hardware 206 may be configured to facilitate (e.g., initiate, execute, manage) the operations of FIG. 5 in order to authenticate the rental candidate based on their mDL. The mDL authentication request comprises the mDL provided as part of the rental initiation request and may be transmitted by communications hardware 206 to an issuing authority system 116A-116N that provisioned the particular mDL to the rental candidate. In some embodiments, the mDL authentication request may be initiated, triggered, and/or executed automatically upon verifying that the rental candidate is in control of the rental candidate device 110A. In some embodiments, the communications hardware 206 may be configured to facilitate the execution of the mDL authentication request based on one or more present or missing features associated with the mDL authentication request. Based on the features that are missing or present (e.g., cryptographic information, desired credential data), the communications hardware 206 may generate an mDL authentication request accordingly. For instance, if the mDL provided by the rental candidate also provided cryptographic information required to decrypt the encrypted mDL, the mDL authentication request may already include the cryptographic information and may not request an issuing authority system 116A for the same, as part of the mDL authentication request.

In some embodiments, the authentication circuitry may generate a digital token based on the mDL authentication request. By way of continued example, the authentication circuitry 210 may be configured to generate a digital token comprising cryptographic information (e.g., public key information) associated with the mDL of the rental candidate. Additionally, in some embodiments, the cryptographic information associated with the mDL of the rental candidate and comprised in the digital token may be rental candidate information by which a rental candidate device 110A of the rental candidate may be uniquely identified.

By way of continued example, the authentication circuitry 210 may leverage the communications hardware 206 to transmit the digital token to an IA system (e.g., IA system 116A) associated with the IA that provisioned the mDL to the rental candidate, such that the IA system (e.g., IA system 116A) may decrypt the cryptographic information comprised in the digital token. In this manner, the IA system (e.g., IA system 116A) may verify one or more portions of credential data associated with the rental candidate device 110A of the rental candidate.

In some embodiments, the authentication circuitry 210 may determine that the IA that provisioned the mDL may no longer be applicable to the rental candidate (e.g., in situations where the rental candidate has moved to a different state). In such cases, the authentication circuitry 210 may be configured to determine the correct IA system (e.g., a different IA system) associated with the rental candidate, such that the respective digital tokens generated based on respective mDL authentication requests are routed to the correct IA systems. In this manner, the rental candidate evaluation system 102 ensures the safe transmission of the respective digital tokens and the successful verification of the respective rental candidate mDLs, thereby authenticating the rental candidate.

As shown by operation 504, the apparatus 200 includes means, such as communications hardware 206, or the like, for receiving a mDL validity response from the IA system, wherein the mDL validity response is indicative of whether the mDL was verified. For example, the communications hardware 206 may receive the mDL validity response from the IA system (e.g., IA system 116A) associated with the IA that provisioned the mDL to the rental candidate. In some embodiments, the mDL validity response is generated based on the digital token associated with the rental candidate and/or the rental candidate device 110A associated with the rental candidate. In some examples, the mDL validity response indicates verified credential data (e.g., desired credential data) associated with the mDL indicated by the mDL authentication request. Furthermore, in some examples, the mDL validity response may also indicate verified information related to the rental candidate device associated with the rental candidate (e.g., rental candidate device 110A).

Finally, as shown by operation 506, the apparatus 200 includes means, such as authentication circuitry 210, or the like, for authenticating the rental candidate based on the mDL validity response. By way of continued example, the authentication circuitry 210 may be configured to authenticate the rental candidate based on the authenticated mDL comprised in the mDL validity response received from the IA system (e.g., one of IA systems 116A-116N). In this manner, the rental candidate evaluation system 102 may be configured to authenticate the rental candidate based on their authenticated mDL.

Returning to FIG. 3, as shown by operation 308, the apparatus 200 includes means such as rental ID management circuitry 208, or the like, for determining a universal rental identifier (ID) associated with the rental candidate. In some embodiments, the universal rental ID may be represented by a code (e.g., alphanumeric, special characters, etc.) that encapsulates various types of data essential for rental evaluation, verification, and management. Examples of such rental data include: (i) identification data (e.g., the name, date of birth, gender of the rental candidate), (ii) government IDs (e.g., references to government-issued identification documents such as mDL number, passport number, or social security number), (iii) contact information (e.g., email address, phone number), (iv) financial information (e.g., credit score, income verification, details of linked payment methods), (v) rental history (e.g., records of past rental transactions, including dates, types of rental candidate items, and rental providers), (vi) feedback and ratings (e.g., aggregating feedback and ratings from previous rentals, which may provide insights into the rental candidate's reliability and behavior), (vi) security and authentication data (e.g., biometric data such as fingerprints, facial recognition data), (vii) digital signatures (e.g., cryptographic signatures that ensure the integrity and authenticity of the rental candidate's identity, (viii) system metadata (e.g. timestamps of previous rental transactions), and/or the like. The purpose of the universal rental ID is to be used across a variety of rental contexts, rental events, and for diverse rental candidate items. Additionally, the universal rental ID may be associated with the mDL of the rental candidate. As such, upon authenticating the rental candidate based on the mDL, the rental ID management circuitry 208 may automatically retrieve the universal rental ID that is linked to the mDL of the rental candidate. The rental ID management circuitry 208 may retrieve the universal rental ID from the smart mobile wallet of the rental candidate device 110A, a rental entity database (e.g., in scenarios where the rental candidate is a returning rental candidate), or from the issuing authority system 116A-116N.

As shown by operation 310, the apparatus 200 includes means such as rental ID management circuitry 208, or the like, for determining rental candidate information based on the universal rental ID. Upon determining that a universal rental ID exists for the rental candidate, the rental ID management circuitry 208 may implement various methods to determine rental candidate information of the rental candidate based on the universal rental ID. For example, if the universal rental ID is represented in an encoded format, the universal rental ID may act as a key to retrieve corresponding rental candidate information regarding the rental candidate from the universal rental ID. Once the corresponding rental candidate information is retrieved, parsing algorithms may decode the rental candidate information into usable components. The decoded components may then be structured into a predefined schema (e.g., personal information may be mapped into fields like name, date of birth, address, contact information, previous rentals, credit score, income verification, bank account details) that establishes a basis for the rental evaluation process. Subsequently, the parsed information may be validated to ensure it is complete and accurate. This may involve checking for mandatory fields and ensuring data types are correct (e.g., ensuring the phone number is numeric). If errors or inconsistencies are found during parsing, the rental ID management circuitry 208 may implement error handling routines to log the error, correct the data, and/or prompt the user for the correct input.

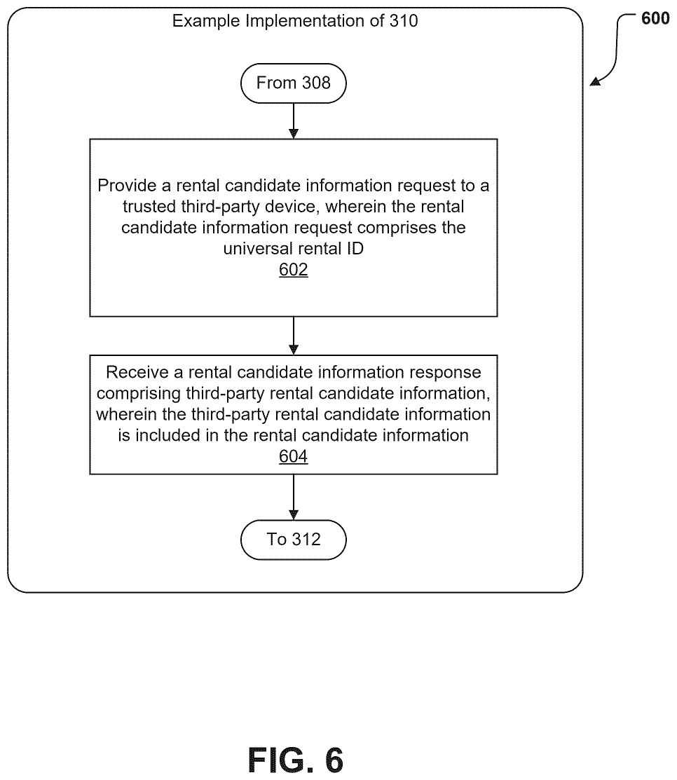

In some embodiments, operation 310 may be performed in accordance with the operations described in FIG. 6. Turning now to FIG. 6, a procedure 600 illustrates example operations for determining rental candidate information based on the universal rental ID.

As shown by operation 602, the apparatus 200 includes means such as communications hardware 206, or the like, for providing a rental candidate information request to a trusted third-party device 114A-114N, wherein the rental candidate information request comprises the universal rental ID. The communications hardware 206 may require specific information and/or verification of rental candidate information from a third party (e.g., credit score, income verification). In some embodiments, the communications hardware 206 may construct a rental candidate information request in a standard data interchange format such as JSON or XML. This request may include the universal rental ID and details about the specific third-party rental candidate information being requested. Additionally, in some embodiments, metadata such as timestamps, request IDs, and authentication tokens may be included in the rental candidate information request to ensure a secure and traceable communication stream. In some embodiments, the rental candidate information request payload may be encrypted using a secure encryption protocol such as AES (advanced encryption standard) to protect the rental candidate information and universal rental ID included in the rental candidate information request during transmission. The transmission may use secure communication protocols (e.g., HTTPS, TLS, etc.) to further ensure data integrity and confidentiality. In some embodiments, the rental entity device 112A may include an API key or an OAuth token in the headers of the rental candidate information request to authenticate and direct the rental candidate information request to a trusted third-party.

As shown by operation 604, the apparatus 200 includes means such as, communications hardware 206, or the like, for receiving a rental candidate information response comprising third-party rental candidate information, wherein the third-party rental candidate information is included in the rental candidate information. The communications hardware 206 may receive the rental candidate information response in an encrypted format, wherein the rental candidate information response has been encrypted using AES or another encryption protocol. In some embodiments, the rental candidate information response may be received by communications hardware 206 over HTTPS or TLS to ensure secure transmission. Upon receiving the rental candidate information response, the communications hardware 206 may decrypt and parse the rental candidate information response to extract the information required by a particular rental entity for performing a rental evaluation. The criteria for a rental evaluation may vary across different rental entities. Thus, in some embodiments, the communications hardware 206 may only extract the information required by a particular entity for performing a rental evaluation and may not extract any additional information beyond the required criteria. In some embodiments, if the user has indicated to the third-party that a rental entity may store the provided rental candidate information in their internal database, the communications hardware 206 may proceed to integrate the provided rental candidate information in the internal database of the particular rental entity. All the aforementioned transactions, including the rental candidate information request and the rental candidate information response must be logged by the rental entity for auditing and troubleshooting purposes.

In some embodiments, the communications hardware 206 may be configured to handle errors in instances where the third-party server is temporarily unavailable. In such cases, the communications hardware 206 may interpret error codes and messages returned by third-party API to take appropriate actions, such as alerting the rental entity and the rental candidate, and/or retrying transmission of the rental candidate information request.

Returning to FIG. 3, as shown by operation 312, the apparatus 200 includes means such as a candidate evaluation engine 212, or the like, for determining, using a risk determination model, a risk level indicative of an inferred risk associated with renting the rental candidate item to the rental candidate, wherein the risk level is determined based on the rental candidate item and rental candidate information. The risk determination model may refer to a system designed to evaluate and predict the risk associated with renting a rental candidate item to a rental candidate. The risk determination model may be a supervised learning model (e.g., logistic regression, decision tree, random forest), an unsupervised learning model (e.g., a clustering algorithm, anomaly detection algorithm), and/or a reinforcement learning model. In particular, the risk determination model may process various data fields received as parts of the rental candidate information and the third-party rental candidate information, such as personal identification data, financial data, rental history, details about the rental item (e.g., type, value, rental conditions, location, duration), and/or the like. The risk level may indicate the likelihood of fraud or default associated with renting the rental candidate item to the rental candidate.

In some embodiments, the candidate evaluation engine 212 may perform feature engineering and create features from the rental candidate information and the third-party rental candidate information by transforming both into a suitable format for the risk determination model. Examples of features include credit score, income level, employment status, punctuality in payments, previous issues or disputes, characteristic of the rental candidate item (e.g., high-value item, short-term vs. long-term rentals, etc.). In some embodiments, categorical features (e.g., employment status, rental item type) may be encoded using techniques such as on-hot encoding or label encoding to convert them into a numerical format that the risk determination model may be able to process.

The risk determination model may be pretrained according to the rental requirements for a particular rental entity. For instance, a rental entity renting low-value music gear may not require rental candidate information related to the employment status of the rental candidate. Alternatively, a property owner seeking to rent a property to a rental candidate for a long timespan may require rental candidate information related to the employment status of the rental candidate. Accordingly, the risk determination model may be catered to the individual needs and requirements of a particular rental entity, and in some embodiments, may be provided with predefined risk levels for a particular risk assessment type.

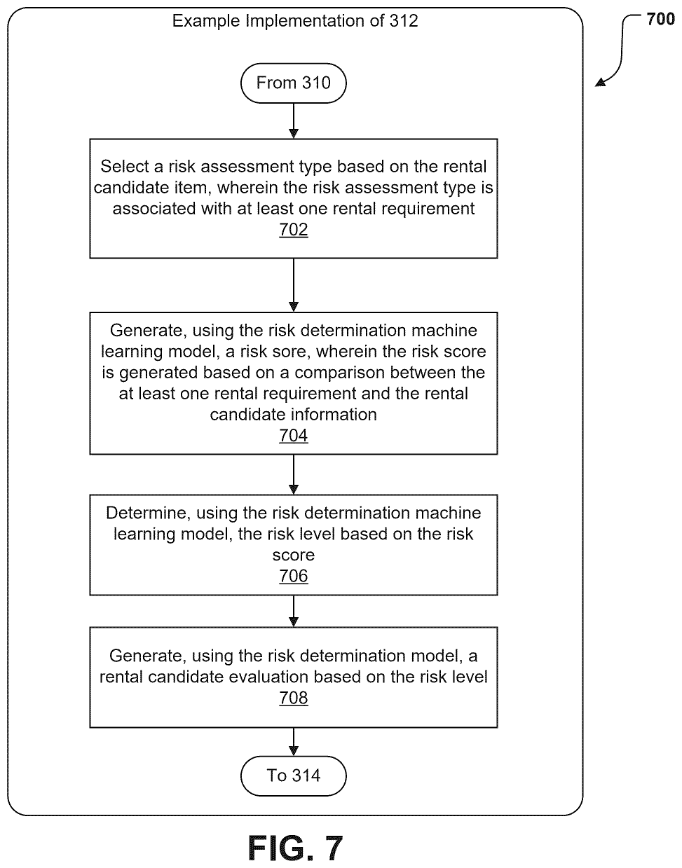

In some embodiments, operation 312 may be performed in accordance with the operations described in FIG. 7. Turning now to FIG. 7, a procedure 700 illustrates example operations for determining, using a risk determination model, a risk level indicative of an inferred risk associated with renting the rental candidate item to the rental candidate, wherein the risk level is determined based on the rental candidate item and rental candidate information.

As shown by operation 702, the apparatus 200 includes means such as, candidate evaluation engine 212, or the like, for selecting a risk assessment type based on the rental candidate item, wherein the risk assessment type (e.g., low risk assessment, medium risk assessment, high risk assessment) is associated with at least one rental requirement and is based on the rental candidate item and rental candidate information. The predefined rental requirements may be criteria set by the rental service to ensure that the rental candidate is a suitable match for the rental asset and to mitigate risk for the rental entity. Consider a scenario where a rental candidate seeks to rent a luxury car. The candidate evaluation engine 212 may query the internal database of the rental candidate evaluation system 102 to identify the rental requirements associated with renting a high-value vehicle, such as requiring the rental candidate to have a high credit score (e.g., above 700), proof of high income or substantial financial assets, clean driving record, no history of vehicle-related claims or disputes. Based on the identified rental requirements, the candidate evaluation engine 212 may consequently select a high-risk assessment type to perform the rental candidate evaluation. In some embodiments, the candidate evaluation engine 212 may be provided with predefined risk assessment type categories for various rental candidate items, such that upon identifying the rental candidate item of interest, the candidate evaluation engine 212 simply needs to query an internal database of the rental entity to identify the risk assessment type appropriate for the particular rental candidate item.

In some embodiments, the candidate evaluation engine 212 may also select a risk assessment type based on the rental candidate information. For instance, if a rental candidate seeks to rent a low-value car, in typical scenarios the candidate evaluation engine 212 may select a low-medium risk assessment type. However, if the rental candidate information indicates that the rental candidate has a low credit score, the candidate evaluation engine 212 may still opt to select a high-risk assessment type.

As shown by operation 704, the apparatus 200 includes means such as, candidate evaluation engine 212, or the like, for generating, using the risk determination model, a risk score, wherein the risk score is generated based on a comparison between the at least one rental requirement and the rental candidate information. In some embodiments, the process of generating a risk score involves comparing each data field in the rental candidate information to the corresponding predefined rental requirements of a rental entity, specific to the type of rental candidate item. By way of continued example, a rental candidate seeking to rent a luxury car must require a credit score of at least 700. The rental candidate's score, as retrieved through the trusted third-party rental information may be 750. As the rental candidate's score exceeds the minimum threshold, this comparison results in a positive outcome, contributing to a lower overall risk for renting the luxury car.

In some embodiments, the risk determination model may be a machine learning model that assigns each data field in the rental candidate information a weight, based on its relative important to the overall risk assessment. For example, a credit score may be given more weight than rental history in the context of high-value vehicle rentals, as financial stability is considered more critical. As such, the risk determination model may normalize the data fields to ensure that they are on a comparable scale by transforming the data into a standard range (e.g., between 0 and 1), to facilitate effective comparison and combination in the risk determination model. Continuing with the aforementioned example, if the rental candidate's score of 750 is normalized on a scale where the maximum possible score is 850, the normalized score might be around 0.88. If the income requirement is an annual salary of $100,000 and the rental candidate's income is $120000, this could be normalized to a value of 1 (assuming $120,000 is the upper cap for normalization). These normalized values may allow the risk determination model to process different types of data on a unified scale. The normalized and weighted data fields may be fed into the risk determination model, which has been trained on historical data to predict the risk associated with various rental scenarios and rental candidate items. The risk determination model may use these inputs to generate a risk score by analyzing patterns and relationships within the data to infer the likelihood of a rental candidate meeting the rental requirements and obligations without incidents. For instance, the risk determination model might recognize that rental candidates with a credit score above 700 and an annual income above $100000 have historically had very low default rates in high-value vehicle rentals. Based on this pattern, the risk determination model may assign a lower risk score to the rental candidate. If the rental candidate's other data fields (e.g., rental history: no prior defaults, background checks, etc.) also meet or exceed the rental requirements, these would further contribute to a favorable risk assessment. Subsequently, the risk determination model may process the combined, normalized data fields to generate and output a composite risk score to the candidate evaluation engine 212. The risk score may refer to a numerical value that represents the overall risk level of renting the rental candidate item to the rental candidate.

In some embodiments, the risk determination model may be a rules-based system that allows a third-party (e.g., a bank) to perform the rental candidate evaluation in place of the rental entity. In particular, the rental entity may provide the third party with the rules and data required to perform a rental candidate evaluation for a particular rental candidate item. For instance, if the rental entity requires proof of income over a particular credit score to rent a luxury car, the rental entity may provide the required credit sore to the third-party. Upon receiving this information, the third-party may query their internal database to verify the proof of income of a rental candidate. Such an automated risk determination process means that the rental candidate is no longer required to share personal information by providing the rental entity with a physical or digital pay stub to show proof of income.

As shown by operation 706, the apparatus 200 includes means, such as candidate evaluation engine 212, or the like, for determining, using the risk determination model, the risk level based on the risk score. Based on the outputted risk score, the candidate evaluation engine 212 may interpret the risk score according to predefined risk levels. For example, a risk score may be categorized into the following risk levels: low risk (0-0.3), medium risk (0.3-0.6), and high risk (0.61-1.0). In reference to the example mentioned above, the rental candidate seeking to rent a luxury car, with a strong credit score, high income, and positive rental history may result in a risk score of 0.25, categorizing them as a low-risk rental candidate. This categorization is generated as a rental candidate evaluation to the rental entity, as described below in operation 708. The rental candidate evaluation simplifies the decision-making process for the rental entity, enabling them to quickly assess the rental candidate's suitability for renting the luxury car.

As shown by operation 708, the apparatus 200 includes means, such as candidate evaluation engine 212, or the like, for generating, using the risk determination model, a rental candidate evaluation based on the risk level. The process by which the rental candidate evaluation may be generated may vary across based on the rental candidate item type and the requirements preestablished by a particular rental entity. In one example embodiment, the rental candidate evaluation may be generated by candidate evaluation engine 212 based on a series of color-coded suitability indications indicating whether the rental entity should rent the rental candidate item to the rental candidate. The suitability indication may be green (“proceed with renting the rental candidate item to the rental candidate”), red (“do not proceed with renting the rental candidate item to the rental candidate”), and/or the like, as determined by the third-party or required by the rental entity. In some embodiments, the rental entity may have predefined the color indications based on their rental requirements criteria, wherein each color represents a different outcome based on the risk assessment and compliance with the rental requirements. If the risk score and risk level indicate that a rental candidate item may be rented to the rental candidate, the candidate evaluation engine 212 may generate a green suitability indication, indicating that the rental candidate meets all the rental requirements and poses a low risk. Alternatively, if the risk score and risk level indicate that a rental candidate item should not be rented to the rental candidate, the candidate evaluation engine 212 may generate a red suitability indication to the rental entity device, indicating that the rental candidate does not meet one or more of the rental requirements and poses a high risk. In some embodiments, the risk score and risk level may not clearly indicate whether a rental candidate item should be rented to the rental candidate, in which case a yellow suitability indication may be generated.

Returning to FIG. 3, as shown by operation 314, the apparatus 200 includes means such as communications hardware 206, or the like, for providing a rental candidate evaluation of the rental candidate to the rental entity device based on the risk level, wherein the rental candidate evaluation comprises a suitability indication of renting the rental candidate item to the rental candidate. In some embodiments, communications hardware 206 may provide the rental candidate evaluation to the rental entity device in example formats such as a visual dashboard (e.g., charts, graphs, and other visual tools to convey risk levels and data insights), numerical risk scores, risk categories (low risk, medium risk, high risk, very high risk, etc.), a detailed risk report (e.g., comprehensive analysis of the rental candidate's risk factors such as credit score, income, rental history, etc.), conditional approval, segmented feedback (e.g., separate evaluations for financial stability, identity verification, and rental history), predictive insights (e.g., predictions about the rental candidate' future behavior based on available historical rental data), comparative analysis (e.g., comparison between the rental candidate and a benchmark or average profile of successful renters), behavioral scores (e.g., evaluating the rental candidate's behavioral pattern based on historical data such as consistency in payment history, frequency of rental applications, etc.), and/or the like.

In instances in which it is not clear whether a rental candidate item should be rented to a rental candidate, a yellow suitability indication may be generated by the candidate evaluation engine 212 and outputted by the communications hardware 206 to the rental entity device. However, in alternate embodiments, the yellow suitability indication may not be outputted to the rental entity device. In the latter case, it would be up to the third-party to decide whether the rental candidate item should be rented to the rental candidate. Once the decision has been made, the third-party may default to providing a predefined color-coded suitability indication of green or red, as previously described in connection with operation 708.

In some embodiments, in which a yellow suitability indication is outputted to the rental entity device by the communications hardware 206, consider the following scenario where the credit score threshold is 700 and a rental candidate has a credit score of 690. In this case, the rental entity device, upon receiving a yellow suitability indication, may request the trusted third-party to provide more context pertaining to the yellow suitability indication. If the rental candidate provides consent and/or has provided consent in the past to share such contextual details with a rental entity, the trusted third-party may share the requested contextual information with the rental entity to help them with determining whether the rental candidate item should be rented to the rental candidate. In some embodiments, the requested contextual information may be quantitative in nature (e.g., credit score), whereas in alternate embodiments, the requested contextual information may be qualitative in nature (e.g., address).

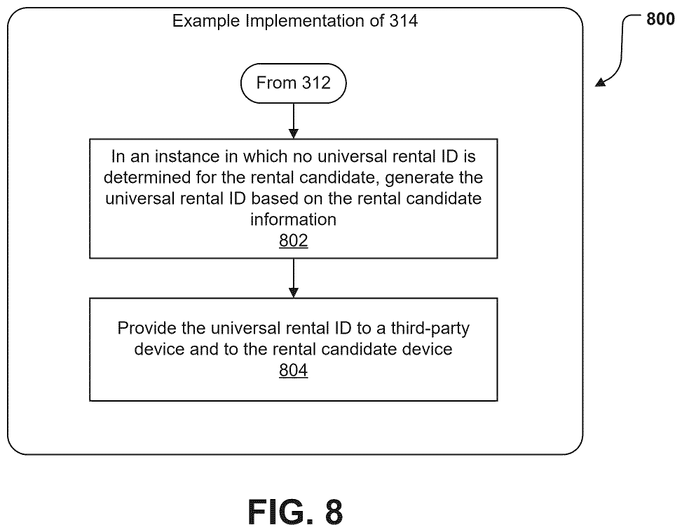

In some embodiments, operation 314 may be performed according to the operations described in FIG. 8. Turning now to FIG. 8, a procedure 800 illustrates example operations for providing a rental candidate evaluation of the rental candidate to the rental entity device based on the risk level, wherein the rental candidate evaluation comprises a suitability indication of renting the rental candidate item to the rental candidate.

As shown by operation 802, the apparatus 200 includes means, such as rental ID management circuitry 208, or the like, for generating the universal rental ID based on the rental candidate information in an instance in which no universal rental ID is determined for the rental candidate. In some embodiments, in which the rental candidate may not have a preexisting universal rental ID, the rental ID management circuitry 208 may generate a novel universal rental ID for the rental candidate. Because the rental ID management circuitry 208 would have access to rental candidate information subsequent to authentication of the mDL, the rental ID management circuitry 208 may utilize the existing information to generate a universal rental ID for the rental candidate. In some embodiments, the rental ID management circuitry 208 may encrypt the rental candidate information and may use secure cryptographic methods to authenticate the encrypted rental candidate information. The rental ID management circuitry 208 may then submit the encrypted rental candidate information to a universal rental ID service that verifies the rental candidate information and generates a unique universal rental ID for the rental candidate. The universal rental ID service may then assign the ID to the rental candidate's record in the universal rental ID service database and may transmit the encrypted universal rental ID back to the rental ID management circuitry 208.

Finally, as shown by operation 804, the apparatus 200 includes means, such as communications hardware 206, or the like, for providing the universal rental ID to a third-party device 114A and to the rental candidate device 110A. The rental ID management circuitry 208 may decrypt the received universal rental ID and subsequently provide the decrypted universal rental ID to communications hardware 206 following which communications hardware 206 may forward the universal rental ID to a third-party device 114A and to the rental candidate device 110A. In some embodiments, the communications hardware may initiate a secure connection with the third-party device 114A using industry-standard encryption protocols, such as TLS. For example, communications hardware 206 may transmit a connection request to the rental candidate device 110A and/or third-party device 114A to which the rental candidate device 110A and/or third-party device 114A may respond and perform a handshake to establish a secure communication channel. The rental entity device 112A may then present its digital certificate, one-time token, or complete a multi-factor authentication method with the rental candidate device 110A and/or third-party device 114A to authenticate itself to one or both of the devices. The rental candidate device 110A and/or third-party device 114A may then verify the certificate against its trusted certificate authorities. Following this step, the universal rental ID, along with any necessary accompanying data may be packaged into a structured data format and transmitted over the secure channel. The rental entity device 112A may create a data packet containing the universal rental ID and additional request details, encrypt the data packet using the session keys established during the TLS handshake, and send the encrypted packet back to the third-party device 114A via the secure channel. In some embodiments, the rental candidate device 110A may store the universal rental ID in the smart mobile wallet and may also associate the universal rental ID with a preexisting mDL.

Returning to FIG. 3, as shown by operation 316, the apparatus 200 includes means such as authentication circuitry 210, or the like, for ending procedure 300 in an instance in which the rental candidate is not successfully authenticated based on the mDL. In some embodiments, if the authentication circuitry 210 determines that the rental candidate's mDL is inauthentic, the authentication circuitry 210 may be configured to generate an inauthentic mDL alert. In particular, an inauthentic mDL alert may be an alert, notification, warning, advisory, and/or the like that indicates various data related to a failed mDL authentication attempt. The inauthentic mDL alert may comprise data (e.g., rental candidate information, timestamp data associated with the mDL authentication attempt, geolocation data associated with the rental candidate during a time in which the mDL authentication attempt was executed, as indicated by GPS data collected and/or generated by a rental candidate device) related to a rental candidate whose mDL was not successfully verified to be authentic.

In some embodiments, an inauthentic mDL alert may be configured as a notification, email, text message, direct application message (e.g., via a software application instance associated with the rental candidate evaluation system 102), audio message (e.g., automated voice message), banner notification, and/or the like. The authentication circuitry 210 may be configured to leverage the communications hardware 206 to transmit the inauthentic mDL alert to one or more computing devices (e.g., rental candidate device 110A-110N, rental entity device 112A-112N, third-party device 114A-114N, IA systems 116A-116N, and/or the like) via a number of different communication methods over a communications network (e.g., communications network 108). In alternate embodiments wherein the verification of the mDL authenticity indicates that the recipient mDL is inauthentic (e.g., due to a corrupted mDL), operation 314 may failover to a traditional rental evaluation process to evaluate the rental candidate.

FIGS. 3-8 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable efficient evaluation of rental candidates during a rental event. Example embodiments thus provide tools that overcome the problems faced by conventional rental candidate evaluation mechanisms and techniques. By avoiding the use of conventional rental candidate evaluation mechanisms and techniques, example embodiments thus save time and resources, while also eliminating the need for manual verification and authentication of rental candidates. Moreover, embodiments described herein counter a wide range of emerging risks in an evolving technological landscape. Finally, by automating functionality that has historically required human analysis, the speed and consistency of the rental evaluations performed by example embodiments unlocks many potential new functions that have historically not been available, such as the ability to conduct near-real-time evaluation of rental candidates.

For instance, by utilizing mDLs to authenticate rental candidates for a rental event, example embodiments provide protection against the loss, theft, and/or misuse of rental candidate information shared with rental entities during conventional rental events. As such, by streamlining and automating the rental evaluation process for a rental event, resources and material costs are significantly lowered for rental entities. Example embodiments also reduce the technical complexity of requiring manual verification and authentication of rental candidates. As such, example embodiments provide additional layers of security to ensure the accurate and efficient evaluation of rental candidates for a particular rental event.

Moreover, example embodiments contemplated herein provide technical solutions that solve real-world problems faced by rental entities who wish to safely perform rental evaluation of rental candidates by employing various mDL-based authentication techniques. While confirming the identity of a rental candidate has been a technical challenge for several years, the sophistication of identity fraud and impersonation techniques have made this problem significantly more acute. By utilizing a legally issued mDL to authenticate the identity of a rental candidate and perform a rental evaluation, embodiments of the present disclosure ensure that rental candidates are properly verified and/or authenticated for a particular rental evaluation, thereby increasing the security and safety of the rental evaluation process for both a rental candidate and a rental entity.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for evaluating a rental candidate for a rental event, the method comprising:
receiving, by communications hardware and from a rental entity device, a rental initiation request comprising (a) a rental candidate item and (b) an indication of a rental candidate;
receiving, by the communications hardware and from a rental candidate device, a mobile driver's license (mDL) associated with the rental candidate;
authenticating, by authentication circuitry, the rental candidate based on the mDL; and
in response to authenticating the rental candidate:
determining, by rental ID management circuitry, a universal rental identifier (ID) associated with the rental candidate;
determining, by the rental ID management circuitry, rental candidate information based on the universal rental ID;
determining, by a candidate evaluation engine and using a risk determination model, a risk level indicative of an inferred risk associated with renting the rental candidate item to the rental candidate, wherein the risk level is determined based on the rental candidate item and rental candidate information; and
providing, by the communications hardware and to the rental entity device, a rental candidate evaluation of the rental candidate, wherein the rental candidate evaluation comprises a suitability indication of renting the rental candidate item to the rental candidate.

2. The method of claim 1, further comprising determining, by the authentication circuitry, that the rental candidate device is associated with the rental candidate based on the indication of a rental candidate.

3. The method of claim 1, further comprising providing, by the communications hardware, a mDL request to the rental candidate device, wherein the mDL is received in response to the mDL request and the mDL is encrypted.

4. The method of claim 1, wherein authenticating the rental candidate further comprises:
providing, by the communications hardware, an mDL authentication request to an issuing authority (IA) system associated with an IA that provisioned the mDL to the rental candidate, wherein the mDL authentication request comprises the mDL;
receiving, by the communications hardware, a mDL validity response from the IA system, wherein the mDL validity response is indicative of whether the mDL was verified; and
authenticating, by the authentication circuitry, the rental candidate based on the mDL validity response.

5. The method of claim 1, wherein determining the risk level further comprises:
selecting, by the candidate evaluation engine, a risk assessment type based on the rental candidate item, wherein the risk assessment type is associated with at least one rental requirement;
generating, by the candidate evaluation engine and using the risk determination model, a risk score, wherein the risk score is generated based on a comparison between the at least one rental requirement and the rental candidate information;
determining, by the candidate evaluation engine and using the risk determination model, the risk level based on the risk score; and
generating, by the candidate evaluation engine and using the risk determination model, a rental candidate evaluation based on the risk level.

6. The method of claim 1, further comprising:
providing, by the communications hardware, a rental candidate information request to a trusted third-party device, wherein the rental candidate information request comprises the universal rental ID; and
receiving, by the communications hardware, a rental candidate information response comprising third-party rental candidate information, wherein the third-party rental candidate information is included in the rental candidate information.

7. The method of claim 1, further comprising:
in an instance in which no universal rental ID is determined for the rental candidate, generating, by rental ID management circuitry, the universal rental ID based on the rental candidate information; and
providing, by communications hardware, the universal rental ID to a third-party device and to the rental candidate device.

8. An apparatus for evaluating a rental candidate for a rental event, the apparatus comprising:
communications hardware configured to:
receive, from a rental entity device, a rental initiation request comprising (a) a rental candidate item and (b) an indication of a rental candidate, and
receive, from a rental candidate device, a mobile driver's license (mDL) associated with the rental candidate;
authentication circuitry configured to authenticate the rental candidate based on the mDL;
rental ID management circuitry configured to, in response to authenticating the rental candidate:
determine a universal rental identifier (ID) associated with the rental candidate, and
determine rental candidate information based on the universal rental ID; and
a candidate evaluation engine configured to:
determine, using a risk determination model, a risk level indicative of an inferred risk associated with renting the rental candidate item to the rental candidate, wherein the risk level is determined based on the rental candidate item and rental candidate information,
wherein the communications hardware is further configured to provide, to the rental entity device and based on the risk level, a rental candidate evaluation of the rental candidate, wherein the rental candidate evaluation comprises a suitability indication of renting the rental candidate item to the rental candidate.

9. The apparatus of claim 8, wherein the authentication circuitry is further configured to:
determine that the rental candidate device is associated with the rental candidate based on the indication of a rental candidate.

10. The apparatus of claim 8, wherein the communications hardware is further configured to:
provide a mDL request to the rental candidate device, wherein the mDL is received in response to the mDL request and the mDL is encrypted.

11. The apparatus of claim 8, wherein the communications hardware is further configured to:
provide an mDL authentication request to an issuing authority (IA) system associated with an IA that provisioned the mDL to the rental candidate, wherein the mDL authentication request comprises the mDL; and
receive a mDL validity response from the IA system, wherein the mDL validity response is indicative of whether the mDL was verified,
wherein the authentication circuitry is further configured to authenticate the rental candidate based on the mDL validity response.

12. The apparatus of claim 8, wherein the candidate evaluation engine is further configured to:
select a risk assessment type based on the rental candidate item, wherein the risk assessment type is associated with at least one rental requirement;
generate, using the risk determination model, a risk score, wherein the risk score is generated based on a comparison between the at least one rental requirement and the rental candidate information;
determine, using the risk determination model, the risk level based on the risk score; and
generate, using the risk determination model, a rental candidate evaluation based on the risk level.

13. The apparatus of claim 8, wherein the communications hardware is further configured to:
provide a rental candidate information request to a trusted third-party device, wherein the rental candidate information request comprises the universal rental ID; and
receive a rental candidate information response comprising third-party rental candidate information, wherein the third-party rental candidate information is included in the rental candidate information.

14. The apparatus of claim 8, wherein the rental ID management circuitry is further configured to:
in an instance in which no universal rental ID is determined for the rental candidate, generate the universal rental ID based on the rental candidate information,
wherein the communications hardware is further configured to provide the universal rental ID to a third-party device and to the rental candidate device.

15. A computer program product for evaluating a rental candidate for a rental event, the computer program product comprising at least one non-transitory computer readable storage medium storing software instructions that, when executed, cause an apparatus to:
receive, from a rental entity device, a rental initiation request comprising (a) a rental candidate item and (b) an indication of a rental candidate;
receive, from a candidate device, a mobile driver's license (mDL) associated with the rental candidate;
authenticating the rental candidate based on the mDL;
in response to authenticating the rental candidate:
determine a universal rental identifier (ID) associated with the rental candidate;
determine rental candidate information based on the universal rental ID;
determine, using a risk determination model, a risk level indicative of an inferred risk associated with renting the rental candidate item to the rental candidate, wherein the risk level is determined based on the rental candidate item and rental candidate information; and
provide, to the rental entity device, based on the risk level, a rental candidate evaluation of the rental candidate, wherein the rental candidate evaluation comprises a suitability indication of renting the rental candidate item to the rental candidate.

16. The computer program product of claim 15, wherein the software instructions, when executed, further cause the apparatus to:
determine that the rental candidate device is associated with the rental candidate based on the indication of a rental candidate.

17. The computer program product of claim 15, wherein the software instructions, when executed, further cause the apparatus to:
provide a mDL request to the rental candidate device, wherein the mDL is received in response to the mDL request and the mDL is encrypted.

18. The computer program product of claim 15, wherein the software instructions, when executed, further cause the apparatus to:
provide an mDL authentication request to an issuing authority (IA) system associated with an IA that provisioned the mDL to the rental candidate, wherein the mDL authentication request comprises the mDL;
receive a mDL validity response from the IA system, wherein the mDL validity response is indicative of whether the mDL was verified; and
authenticate the rental candidate based on the mDL validity response.

19. The computer program product of claim 15, wherein the software instructions, when executed, further cause the apparatus to:
select a risk assessment type based on the rental candidate item, wherein the risk assessment type is associated with at least one rental requirement;
generate, using the risk determination model, a risk score, wherein the risk score is generated based on a comparison between the at least one rental requirement and the rental candidate information;
determine, using the risk determination model, the risk level based on the risk score; and
generate, using the risk determination model, a rental candidate evaluation based on the risk level.

20. The computer program product of claim 15, wherein the software instructions, when executed, further cause the apparatus to:
provide a rental candidate information request to a trusted third-party device, wherein the rental candidate information request comprises the universal rental ID; and
receive a rental candidate information response comprising third-party rental candidate information, wherein the third-party rental candidate information is included in the rental candidate information.
